(19) United States
(12) Patent Application Publication
(10) Pub. No.: US 2026/0222557 A1
(43) Pub. Date: Jul. 30, 2026

(54) INTER PREDICTION BY USING PREDICTION MODEL

(71) Applicant: Tencent America LLC, Palo Alto, CA (US)

(72) Inventors: Lien-Fei CHEN, Palo Alto, CA (US); Yonguk YOON, Palo Alto, CA (US); Roman CHERNYAK, Santa Clara, CA (US); Biao WANG, San Jose, CA (US); Ziyue XIANG, Palo Alto, CA (US); Yifan WANG, Palo Alto, CA (US); Shan LIU, San Jose, CA (US)

(73) Assignee: Tencent America LLC, Palo Alto, CA (US)

(21) Appl. No.: 19/367,723

(22) Filed: Oct. 23, 2025

Related U.S. Application Data
(60) Provisional application No. 63/751,807, filed on Jan. 30, 2025.

(51) Int. Cl. H04N 19/109; H04N 19/176; H04N 19/186

(52) U.S. Cl. CPC H04N 19/109; H04N 19/176; H04N 19/186

(57) ABSTRACT

A video bitstream including coded information of a current block in a current picture of a video is received. Parameters of a model are determined based on the coded information in the video bitstream. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is reconstructed based on the prediction block.

### INCORPORATION BY REFERENCE

The present application claims the benefit of priority to U.S. Provisional Application No. 63/751,807, “SIGNAL ENHANCEMENT OF INTER PREDICTION BY USING PREDICTION MODEL” filed on Jan. 30, 2025, which is incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage, and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream including coded information of a current block in a current picture of a video is received. Parameters of a model are determined based on the coded information in the video bitstream. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is reconstructed based on the prediction block.

According to another aspect of the disclosure, a method of video encoding is provided. In the method, parameters of a model for a current block in a current picture of a video are determined. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is encoded in a bitstream based on the prediction block.

According to yet another aspect of the disclosure, a non-transitory computer-readable storage medium is provided. The non-transitory computer-readable storage medium stores instructions which when executed by a processor cause the processor to perform an encoding method. In the encoding method, parameters of a model for a current block in a current picture of a video are determined. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is encoded in a bitstream based on the prediction block. The encoded bitstream is further transmitted.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods.

Technical solutions of the disclosure include methods and apparatuses related to inter prediction signal enhancement by using a signaled prediction model. In an example, a video bitstream including coded information of a current block in a current picture of a video is received. Parameters of a model are determined based on the coded information in the video bitstream. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is reconstructed based on the prediction block. Therefore, coding efficiencies and accuracies are improved based on the inter prediction signal enhancement by using the signaled prediction model.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an example of local illumination compensation model derivation.

FIG. 5 shows a flow chart outlining an example of an inter prediction signal enhancement by using a signaled prediction model.

FIG. 6 is a block diagram illustrating an example of the inter prediction signal enhancement by using the signaled prediction model.

FIG. 7 shows a flow chart outlining a decoding process according to some aspects of the disclosure.

FIG. 8 shows a flow chart outlining an encoding process according to some aspects of the disclosure.

FIG. 9 is a schematic illustration of a computer system in accordance with an aspect.

### DETAILED DESCRIPTION

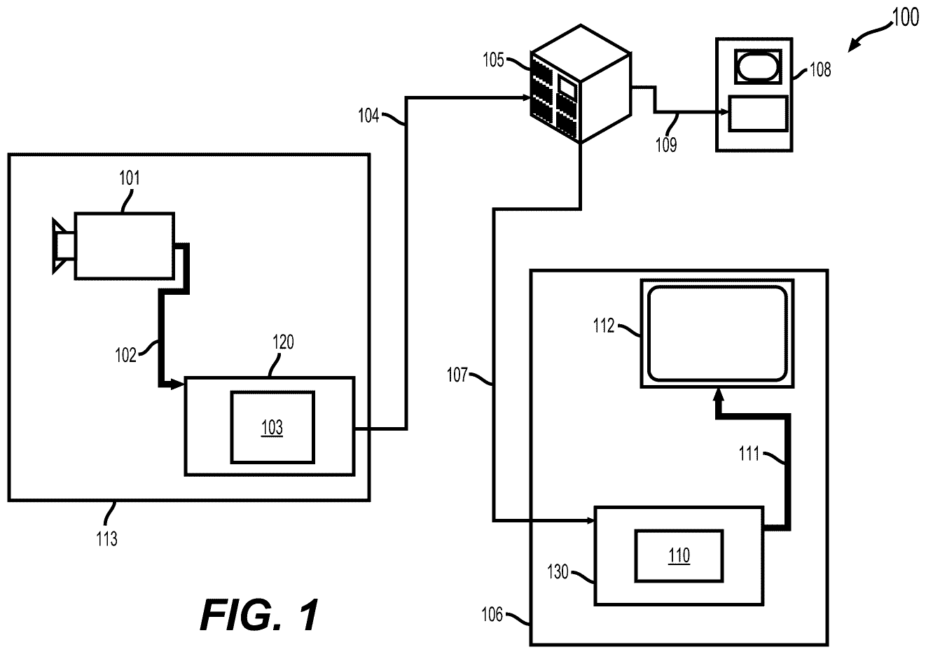

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

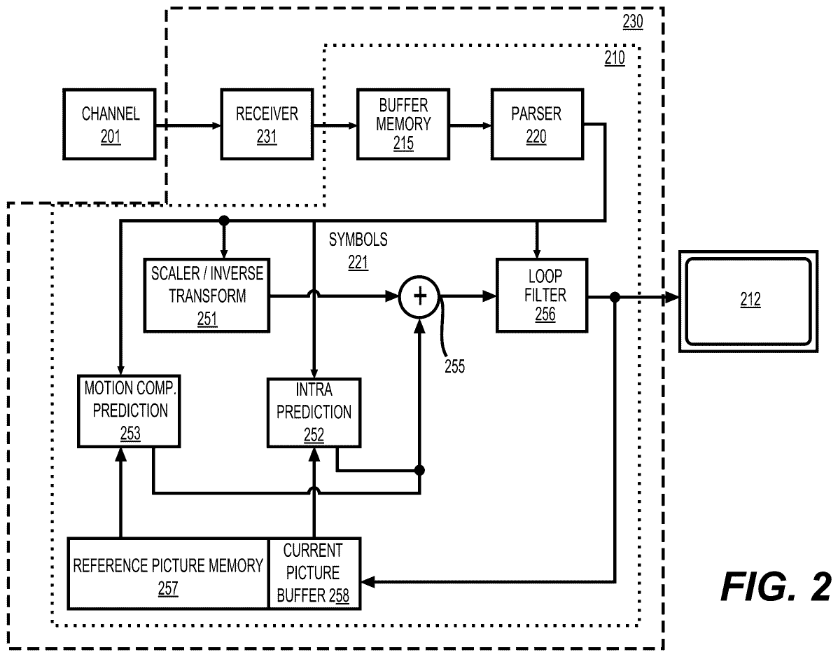

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

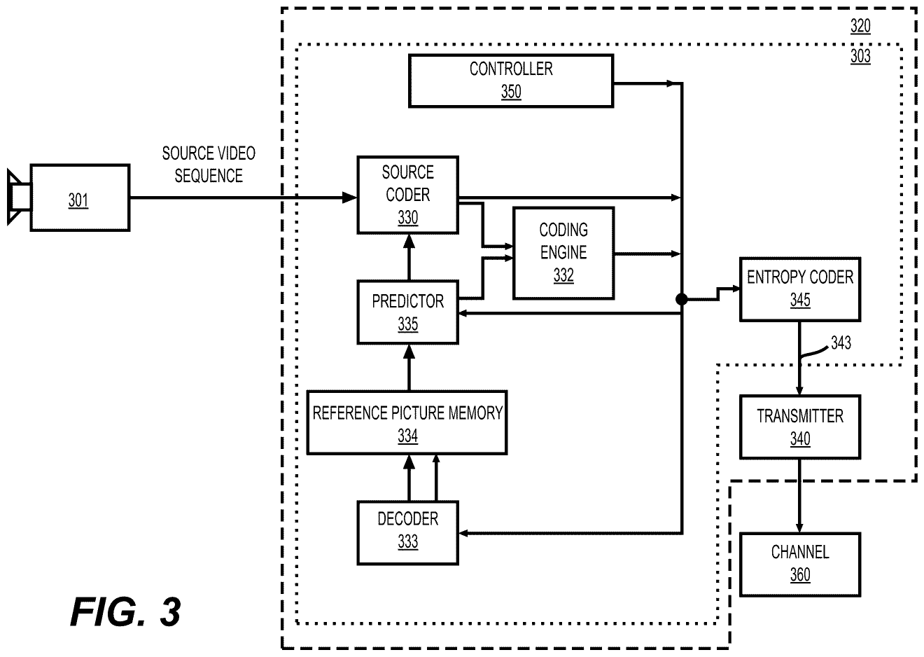

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, ...), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques related to inter prediction signal enhancement by using a signaled prediction model.

Video coding has been widely used in many applications, such as broadcasting, video recording, and video streaming. Various emerging video coding standards, such as H.264, H.265/HEVC, H.266/VVC, and AV1 are published and widely adopted in the aforementioned applications. A hybrid video codec may include various coding modules, such as intra prediction, inter prediction, transform coding, quantization, entropy coding, and post in-loop filter.

Adaptive loop filtering and cross-component adaptive loop filtering are used in video coding to minimize an error between original samples and coded samples by using a filter, such as a wiener-based adaptive filter. Filter coefficients of the adaptive loop filter may be derived by solving a Wiener-Hopf equation. In order to improve model accuracy, multiple classifiers may be utilized to classify each sample and an associated filter coefficient may be applied to the sample. In an example, an adaptive loop filter is located at a last processing stage of video coding for each picture and is regarded as a tool to restore an image from a lossy coding loop. In an example, suitable filter coefficients may be determined by an encoder and further be signaled to a decoder.

Illumination (or illuminance) compensation methods, such as local illumination compensation, are used to model an illumination variation between a current block and a prediction block of the current block as a function of illumination variation between a current block template constructed by using adjacent reconstructed sample data of the current block and a reference block template.

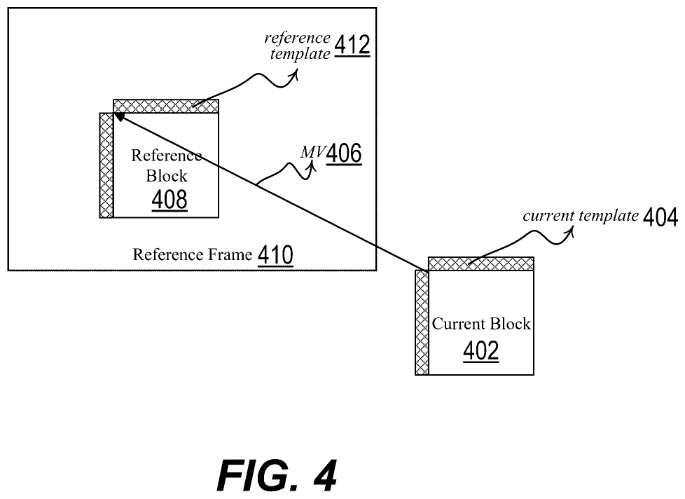

FIG. 4 shows a schematic illustration of an example of local illumination (or illuminance) compensation (LIC) model derivation. As shown in FIG. 4, a current block (402) has a current block template (404) formed based on reconstructed neighboring samples of the current block (402). The current block has a reference block (408) that is included in a reference frame (410) and indicated by a motion vector (MV) (406). The reference block (408) has a reference block template (412). According to samples in the current block template (404) and samples in the reference block template (412), a scaling factor α indicating a gain or contrast compensation and an offset β indicating a brightness compensation are determined (e.g., derived). A prediction of the current block is defined as follows in equation (1) according to the LIC model:

Pred(x,y)=α·Ref(x′,y′)+β Eq. (1)

where Pred(x,y) is a predicted sample for the current block, Ref(x′,y′) is a sample in the reference block pointed to by the motion vector, α is the scaling factor (gain/contrast compensation), and β is the offset (brightness compensation).

Aspects of the disclosure include applying a model to an inter prediction block (or a motion compensated block) of a coding block to derive a final inter prediction block for the coding block when the coding block is coded in a predefined mode, such as an inter prediction mode. Parameters of the model are signaled in a bitstream, such as at a slice level, a picture level, or a filter parameter level. The parameters of the model may also be referred to as coefficients of filtering, such as coefficients of an adaptive loop filter.

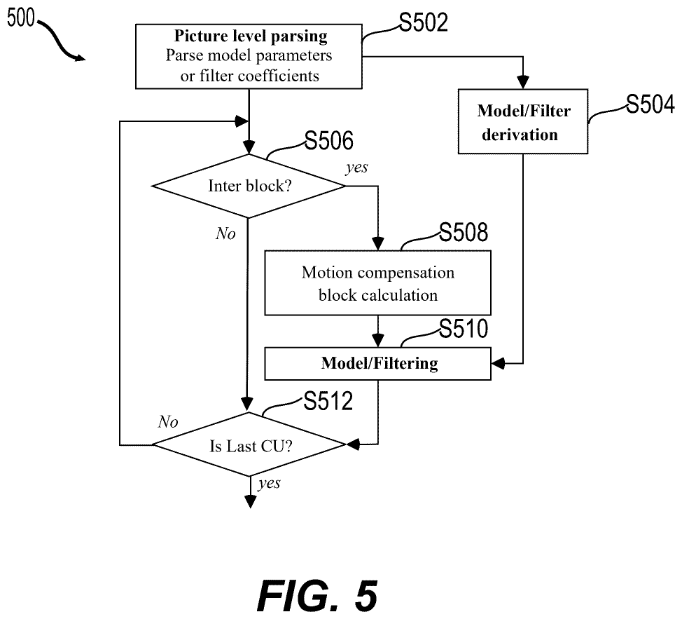

FIG. 5 shows a flowchart (500) of tan example of a method applied to an inter prediction block in which an inter prediction signal is enhanced by using the signaled prediction model.

As shown in FIG. 5, a picture level parsing is performed at step (S502) in which model parameters or filter coefficients are parsed or otherwise determined. For example, model parameters of a model or filter coefficients of a filter are determined by parsing coded information (e.g., coded syntax elements) of a current block in a bitstream. The process (500) proceeds to step (S504) in which a model and/or a filter is derived. For example, a model or a filter is derived based on a motion compensated picture of the current picture and the current picture. In an example, the motion compensated picture is a synthesized picture that functions as a reference picture of the current picture. In an example, the motion compensated picture is a pseudo prediction picture (e.g., an intermediate prediction picture) or a candidate prediction picture from a candidate list for the current picture. At step (S506), whether a current block in the current picture is inter coded is determined. When the current block is not inter coded, the process (500) proceeds to step (S512). At step (S512), whether the current block is a last coding unit (CU) is determined. When the current picture is determined to be coded by an inter prediction mode, at step (S508), a motion compensation block (or motion compensated block) is calculated based on the inter prediction mode. At step (S510), the model or the filter that is determined at step (S504) is applied to the motion compensated block to generate a prediction block for the current block.

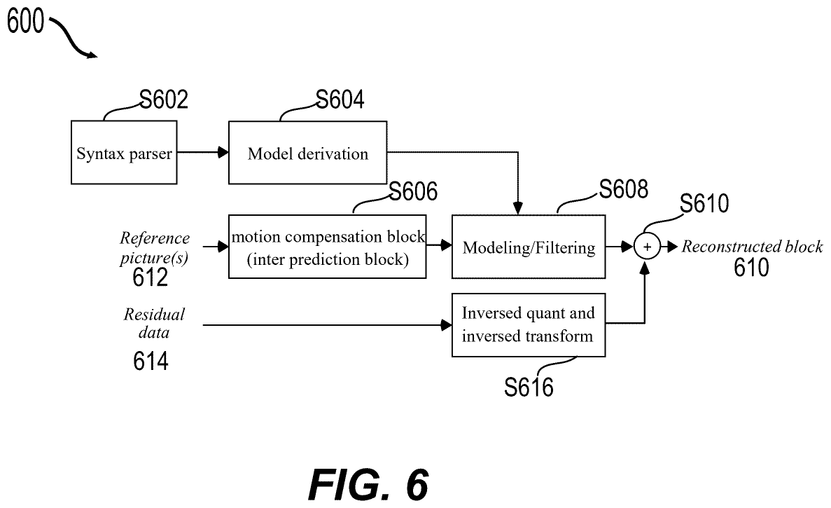

FIG. 6 shows a block diagram of an example of a method (600) at a decoder-side in which inter prediction signal is enhanced by using a signaled prediction model. As shown in FIG. 6, syntax elements in a bitstream are parsed at step (S602). The syntax elements include parameter information of a model or a filter and are determined (e.g., derived) at an encoder. For example, the model or the filter is determined by the encoder based on a motion compensated picture of a current picture and the current picture. The model or the filter indicates a correlation between the motion compensated picture and the current picture.

At step (S604), according to the parsed syntax elements, the model or the filter is derived. At step (S606), a motion compensated block (or inter prediction block) is determined for a current block in the current picture based on a reference block in a reference picture. At step (S608), the model or the filter is applied to the motion compensated block to generate a prediction block of the current block. At step (S610), a reconstructed block of the current block is determined based on a combination of the prediction block generated at step (S608) and a prediction residual. The prediction residual is generated by performing an inverse quantization and a subsequent inverse transformation at step (S616) on residual data (614).

In an aspect, the model is determined using a linear polynomial equation or a non-linear polynomial equation. In an example, the model is expressed as a linear or non-linear polynomial model.

In an aspect, the model is a multi-model with a specific model classifier and the model classifier is a predefined classifier for each coding picture. In an example, the model is a multi-model that uses a predefined classifier specific to each coding picture. In an example, the model utilizes a multi-model architecture where a selection of a specific sub-model is governed by a predefined classifier that is determined for each individual coding picture.

In an aspect, the model is a filtering model with N-tap filter coefficients. In an example, the model is an N-tap filter, where N is a positive integer.

In an aspect, the model is a filtering model with multiple classifiers and each classifier has corresponding N-tap filter coefficients. Thus, according to the classifiers, respective N-tap filter coefficients are determined for each of the classifiers in the model.

In an example, the classifier may be, without limitation, a classifier used in an adaptive loop filter (ALF). In another example, directional, variance-based, or sample-value-based classification with up to 25 classes may be employed.

In an example, a plurality of classifiers may share a same filter coefficient set (or a same set of filter coefficients).

In an aspect, a flag is signaled. For example, the flag is firstly signaled at a slice level or a picture level to indicate whether the proposed method is to be applied to an inter prediction block or not. If the flag is true, associated parameter(s) or coefficient(s) is/are further parsed.

In an example, a flag is signaled to indicate whether parameter(s) or coefficient(s) in a previous coding slice or a previous coding picture is used or not. If the flag is true, a syntax is further signaled to indicate which one of previous coding slices or previous coding picture is selected. Parameter(s) or coefficient(s) is/are further determined from the selected previous coding slice or the selected previous coding picture.

In an example, the syntax is signaled. For example, the syntax is signaled at a slice, a picture, a coding unit (CU), a coding tree unit (CTU), or the like.

In some aspects, the flag is determined to be implicitly false based on one more conditions. The conditions may be related to the reference picture or prediction mode.

In an example, the flag is implicitly false when a reference picture is not available in a decoded picture buffer.

In an example, the flag is implicitly false when a current coding slice or a current coding picture is coded as an intra coding slice or an intra coding picture.

In an aspect, a block level flag is signaled to indicate whether the method is applied to a coding block or not. If the flag is true, the derived model is applied to the coding block.

In an aspect, the method is applied to an inter prediction block of a current block. A blending operation is performed to blend (i) the inter prediction block processed by the proposed method and (ii) an intra prediction block to obtain a final prediction block of the current block when a combined inter and intra prediction (CIIP) mode is used.

In an aspect, the method is applied to certain geometric partitions. For example, the method is applied to a geometric partition which is predicted from an inter prediction only.

In an example, a current block is partitioned into two geometric partitioned portions according to a geometric partition mode. Inter prediction blocks are further determined for the two geometric partitioned portions according to the inter prediction. The method is applied to each of the inter prediction blocks to obtain geometric prediction blocks. A geometric partition mask is applied to both the geometric prediction blocks to obtain a final prediction block of the current block in the geometric partition mode. In some aspects, the geometric partition mask is binary or uses fixed weights on either side of the partition line. In an example, the geometric partition mask is a map with a same size as the current block, where pixels on one side of the partition line of the geometric partition mode are set to first values (e.g., a first weight factor) and pixels on the other side are set to second values (e.g., a second weight factor). In an example, the geometric partition mask acts as a weighting function.

In an aspect, a multi hypothesis model is applied to generate multiple motion compensated blocks (or inter prediction blocks) for a current block. The method is applied to each inter prediction block respectively, and a blend (e.g., a weighted average) is applied to obtain a final prediction block of the current block according to the multi hypothesis mode.

In an aspect, the method is applied to a prediction block firstly, and a luma reshaping or mapping is applied to convert prediction data (e.g., luma prediction data) of the prediction block into a mapped domain.

In an example, the luma reshaping or mapping adjusts a distribution of luma values (or luma samples) to make the luma values more “compressible” before luma samples are processed by a main coding pipeline. In an example, the luma reshaping or mapping may include a forward mapping at an encoder and an inverse mapping at a decoder. At the encoder, original luma values are mapped to a new, compressed range according to a model (e.g., a piecewise linear model based on pivot points). At the decoder, after the video has been reconstructed, the inverse mapping is applied. The inverse mapping may restore the luma values to their original, pre-mapped range based on the pivot points received from the bitstream.

In an aspect, the method is applied to certain prediction blocks. For example, the method is applied to a prediction block which is not coded in a local illumination compensation mode.

In an example, a flag is signaled to indicate whether the method is applied. For example, the flag indicates whether the method is applied to a coding inter block or not when the coding inter block is not coded in the local illumination compensation mode.

In an aspect, the method is applied to a motion compensated block before the local illumination compensation is applied to the motion compensated block or after the local illumination compensation is applied to the motion compensated block.

In an aspect, the method is applied to a motion compensated block only if the motion compensated block is not coded by any decoder-side optical-flow-based methods. The decoder-side optical-flow-based methods may include a bi-directional optical flow (BDOF), a prediction refinement with optical flow (PROF), or the like.

In an aspect, the proposed method is applied to a motion compensated block before a decoder-side optical-flow-based method is applied to the motion compensated block or after the decoder-side optical-flow-based method is applied to the motion compensated block.

In an aspect, two inter prediction blocks are generated according to a bi-prediction mode. The method is applied to each inter prediction block (or motion compensated block) respectively. A blending (e.g., weighting) is applied subsequently to generate a weighted average (or weighting average) of the two inter prediction blocks.

In an aspect, the method is applied to a luma prediction data to predict a chroma prediction block.

In an example, predicted chroma prediction data is blended with a chroma prediction block to obtain a final chroma prediction block.

In an example, the predicted chroma prediction data is an offset value that is to be added to chroma prediction data to obtain a final chroma prediction data.

In an example, the method is applied to a luma reconstruction block instead of a luma prediction block to predict the chroma prediction data.

In an example, the method is not only applied to the luma prediction block but also applied to the chroma prediction block and the luma reconstructed block. For example, a correlation is derived based on the luma prediction block and the chroma prediction block. The model of the disclosure is applied to the luma reconstructed block to fine-tune the luma reconstructed block. The correlation is applied to the fine-tuned luma reconstructed block to generate the predicted chroma prediction block.

In an aspect, the method is applied only to a selected frame with a specific temporal ID.

In an example, only frames (or pictures) with temporal identifier (Tid) less than a threshold value are eligible for application of the proposed method.

In an example, only frames with Tid larger than a threshold value are eligible for application of the proposed method.

Aspects of the disclosure include constructing a motion compensated picture of an original input picture (e.g., a current picture) and a model (e.g., a filter) is determined (e.g., derived) based on the motion compensated picture and the original input picture at an encoder. The model, or one or more parameters of the model, is signaled in a bitstream for a decoder usage. In an example, the motion compensated picture is a synthesized picture, a pseudo prediction, or a candidate prediction for the original input picture.

In an aspect, a motion compensated picture is constructed by using a plurality of N×N motion compensated blocks in a raster scanning order. N is a positive integer, such as 8.

In an example, the motion compensated block is either uni-prediction or bi-prediction. For example, the motion compensated block is determined based on a uni-prediction mode or a bi-prediction mode.

In an example, a reference picture for the motion compensated block is one of reference pictures in a decoded picture buffer. For example, the reference picture in which the motion compensated block is positioned is selected from one of the reference pictures in the decoded picture buffer.

In an example, the reference picture for the motion compensated block is one of reference pictures in a reference picture list of the original input picture.

In an aspect, a motion compensated picture is generated by using an optical flow, such as a bi-directional optical flow (BDOF), a prediction refinement with optical flow (PROF), or the like

In an aspect, a motion compensated picture is generated by using a frame rate up conversion (FRUC) technique. The FRUC may include two steps: motion estimation and motion-compensated interpolation. In the motion estimation, two consecutive original frames may be analyzed to determine movement of objects or pixels between the two consecutive original frames. For example, the movement of the objects or pixels may be analyzed by calculating motion vectors, which indicate a displacement of a block of pixels from one frame to the next. Once the motion vectors are determined, the FRUC proceeds to the motion-compensated interpolation in which a new frame is synthesized or “interpolated” at a temporal position between the two original frames. Pixels of the new frame may be populated by moving the pixels from the original frames along motion trajectories of the pixels.

In an aspect, a motion compensated picture is generated by using a temporal motion vector. The temporal motion vector may include a temporal motion vector predictor and/or a subblock-based temporal motion vector predictor with/without temporal scaling.

In an aspect, a motion compensated picture is generated by using a neural network-based reference picture construction.

In an example, an input of the neural network is a reference picture in a reference list of the original input picture.

Aspects of the disclosure include parsing parameter(s) of a model or coefficient(s) of a filter and applying the model or the filter with the parsed parameter(s) or coefficient(s) to a whole coding picture when the coding picture is coded without block level information, such as without any block level information. The block level information includes transformed residual data and/or header information for a coding unit, a CTU, a superblock, or the like

In an aspect, the coding picture without any block level information is constructed (e.g., created) by using a frame rate up conversion technique.

In an aspect, the coding picture without any block level information is constructed by using N×N block-level motion compensation. Each motion compensated block is calculated by using a collocated temporal motion vector with or without temporal scaling, and the collocated temporal motion vector is either uni-prediction from a reference list 0 or a reference list 1, or bi-prediction from both the reference lists 0 and 1. An example of the N is 4, 8, or 16.

In an example, the coding picture is divided into a plurality of N×N blocks. For each block, a collocated block in a previously decoded picture is determined, and the collocated block is also referred to as a temporal collocated block. Motion vectors of the collocated blocks, also referred to as the collocated temporal motion vectors, are applied to identify a plurality of motion compensated blocks from a reference frame for the N×N blocks of the coding picture. When the reference frame indicated by the collocated temporal motion vectors is at a different temporal distance than a target reference frame of the current picture, a temporal scaling may be applied to the collocated temporal motion vectors by a ratio of a temporal distance between the coding picture and the target reference frame and a temporal distance between the previously decoded picture and the reference frame indicated by the collocated temporal motion vectors.

In an aspect, the coding picture without any block level information is constructed by using an optical flow derivation method when both forward and backward reference pictures are available.

In an aspect, a flag is signaled to indicate whether the proposed method is applied or not. If the flag is true, the proposed method is applied to a whole slice or a whole picture.

In an aspect, a flag is further signaled to indicate whether parameter(s) or coefficient(s) in a previous coding slice or a previous picture is used or not. If the flag is true, a syntax is further signaled to indicate which one of previous slices or previous pictures is selected. Parameter(s) or coefficient(s) of the selected previous coding slice or the selected previous picture is further applied to the whole slice or the whole picture. In an example, the parameters or coefficients from the previous coding slice or the previous picture are applied directly to the slice or the picture. Thus, the encoder may not need to signal the parameters of the model to the decoder.

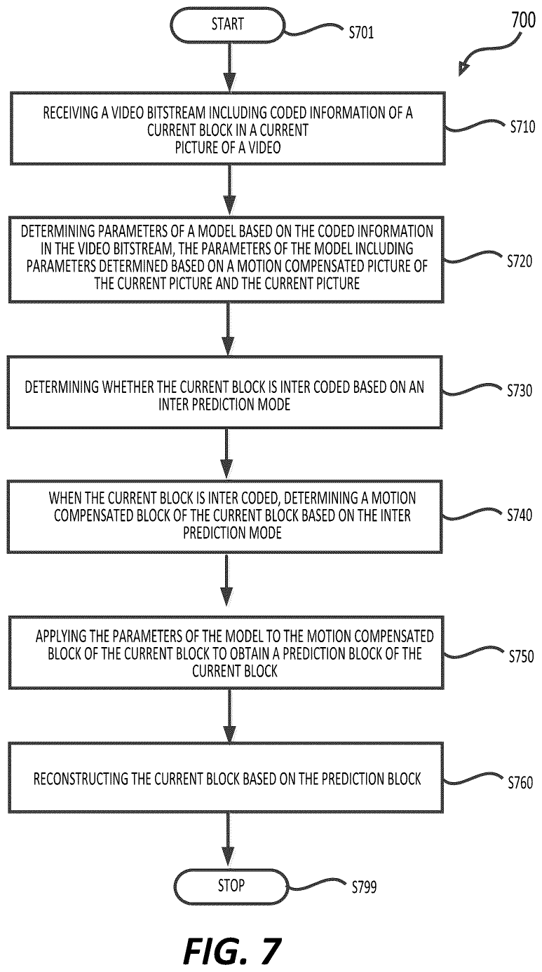

FIG. 7 shows a flow chart outlining a process (700) according to an aspect of the disclosure. The process (700) can be used in a video decoder. In various aspects, the process (700) is executed by processing circuitry, such as the processing circuitry that performs functions of the video decoder (110), the processing circuitry that performs functions of the video decoder (210), and the like. In some aspects, the process (700) is implemented in software instructions, thus when the processing circuitry executes the software instructions, the processing circuitry performs the process (700). The process starts at (S701) and proceeds to (S710).

At (S710), a video bitstream including coded information of a current block in a current picture of a video is received.

At (S720), parameters of a model are determined based on the coded information in the video bitstream. The parameters of the model include parameters determined based on a motion compensated picture of the current picture and the current picture.

At (S730), whether the current block is inter coded based on an inter prediction mode is determined.

At (S740), when the current block is inter coded, a motion compensated block of the current block is determined based on the inter prediction mode.

At (S750), the parameters of the model are applied to the motion compensated block of the current block to obtain a prediction block of the current block.

At (S760), the current block is reconstructed based on the prediction block.

In an aspect, the model includes a plurality of sub-models indicated by a plurality of model classifiers. Each of the plurality of model classifiers corresponds to a respective coded picture of the video.

In an aspect, the model is a filtering model with a plurality of classifiers. Each of the plurality of classifiers corresponds to a respective set of filter coefficients of an N-tap filter, where N is a positive integer. The plurality of classifiers includes at least one of a direction-based classifier, a variance-based classifier, or a sample-value-based classifier.

In an aspect, a first flag in the video bitstream is obtained. The first flag indicates whether the model is to be applied to the current block. When the first flag indicates that the model is to be applied to the current block, the parameters of the model are determined from the coded information.

In an aspect, the coded information includes a second flag indicating whether parameters of previous coding slices or previous coding pictures are applied to the current block. When the second flag indicates that the parameters of the previous coding slices or the previous coding pictures are applied to the current block, the parameters of the model are determined from one of the previous coding slices or one of the previous coding pictures that is indicated by a syntax element in the video bitstream.

In an aspect, the current block is reconstructed based on a combination of the motion compensated block and the prediction block of the current block.

In an aspect, when the current block is partitioned into a first portion and a second portion based on a geometric partition, the parameters of the model are applied to (i) the first portion of the current block to obtain a first prediction portion of the current block and (ii) the second portion of the current block to obtain a second prediction portion of the current block. A geometric partition mask is applied to the first prediction portion and the second prediction portion to obtain the prediction block of the current block.

In an aspect, a luma reshaping or a luma mapping is applied to luma samples of the prediction block to convert the luma samples into a mapped domain.

In an aspect, the parameters of the model are applied to the motion compensated block of the current block when one of (i) a local illumination compensation mode and (ii) a decoder-side optical-flow-based method is not applied to the current block.

In an aspect, when the current block is coded in a bi-prediction mode and the motion compensated block includes a first motion compensated block in a first direction of the bi-prediction mode and a second motion compensated block in a second direction of the bi-prediction mode, the parameters of the model are applied to (i) the first motion compensated block to obtain a first prediction block and (ii) the second motion compensated block to obtain a second prediction block. The prediction block of the current block is determined as a weighted combination of the first prediction block and the second prediction block.

In an aspect, a correlation between a luma prediction component of the motion compensated block and a chroma prediction component of the motion compensated block is determined. A luma reconstructed component of the current block is determined based on the luma prediction component. The parameters of the model are applied to the luma reconstructed component of the current block to obtain a processed luma reconstructed component. A predicted chroma prediction component of the current block is determined based on the determined correlation and the processed luma reconstructed component.

In an aspect, a chroma component of the current block is reconstructed based on a combination of the chroma prediction component of the motion compensated block and the predicted chroma prediction component.

In an aspect, whether the parameters of the model are to be applied to the motion compensated block of the current block is determined based on a comparison between a temporal identifier of the current block and a threshold value.

In an aspect, the motion compensated picture is constructed with a plurality of N×N motion compensated blocks of the current picture in a raster scanning order, where N is a positive integer. A reference picture to determine the plurality of N×N motion compensated blocks is (i) one of reference pictures in a decoded picture buffer or (ii) one of reference pictures in a reference list of the current picture.

In an aspect, the motion compensated picture is determined by one of an optical flow, a frame rate up conversion, a temporal motion vector predictor, a subblock-based temporal motion vector predictor, and a neural network-based reference picture construction.

In an aspect, the parameters of the model are applied to a coded picture when the coded picture is coded without block level information. The block level information includes at least one of transformed residual data and header information of one of a coding unit, a coding tree unit (CTU), and a superblock.

In an aspect, the coded picture is generated based on one of (i) a frame rate up conversion and (ii) an optical flow when a forward reference picture and a backward reference picture of the coded picture are available.

In an aspect, the coded picture is generated based a plurality of N×N motion compensated blocks. Each of the plurality of N×N motion compensated blocks is defined based on a collocated temporal motion vector. The collocated temporal motion vector is one of a uni-prediction motion vector and a bi-directional motion vector.

Then, the process proceeds to (S799) and terminates.

The process (700) can be suitably adapted. Step(s) in the process (700) can be modified and/or omitted. Additional step(s) can be added. Any suitable order of implementation can be used.

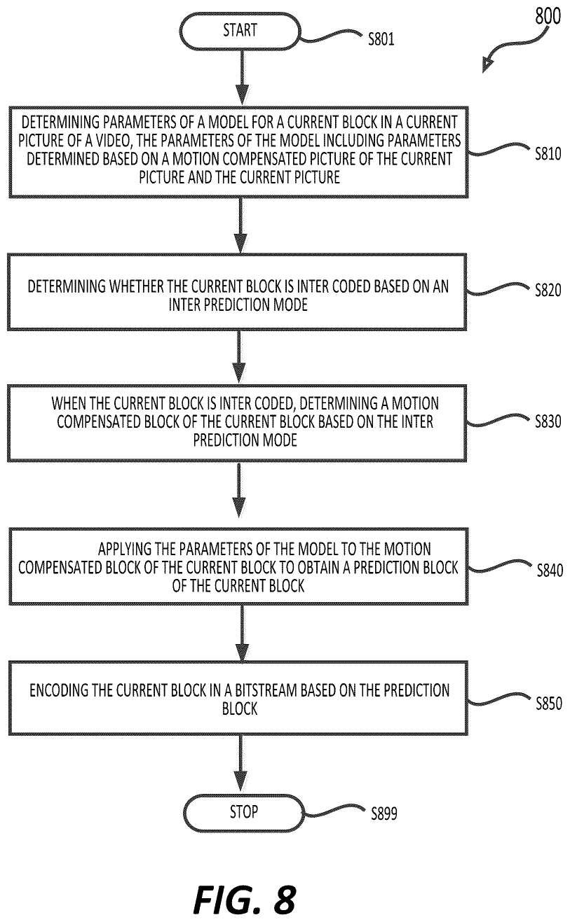

FIG. 8 shows a flow chart outlining a process (800) according to an aspect of the disclosure. The process (800) can be used in a video encoder. In various aspects, the process (800) is executed by processing circuitry, such as the processing circuitry that performs functions of the video encoder (103), the processing circuitry that performs functions of the video encoder (303), and the like. In some aspects, the process (800) is implemented in software instructions, thus when the processing circuitry executes the software instructions, the processing circuitry performs the process (800). The process starts at (S801) and proceeds to (S810).

At (S810), parameters of a model for a current block in a current picture of a video are determined. The parameters of the model include parameters determined based on a motion compensated picture of the current picture and the current picture.

At (S820), whether the current block is inter coded based on an inter prediction mode is determined.

At (S830), when the current block is inter coded, a motion compensated block of the current block is determined based on the inter prediction mode.

At (S840), the parameters of the model are applied to the motion compensated block of the current block to obtain a prediction block of the current block.

At (S850), the current block is encoded in a bitstream based on the prediction block.

Then, the process proceeds to (S899) and terminates.

The process (800) can be suitably adapted. Step(s) in the process (800) can be modified and/or omitted. Additional step(s) can be added. Any suitable order of implementation can be used.

In an aspect, a non-transitory computer-readable storage medium is provided. The non-transitory computer-readable storage medium stores instructions which when executed by a processor cause the processor to perform an encoding method. In the encoding method, parameters of a model for a current block in a current picture of a video are determined. The parameters of the model include parameters determined based on a motion compensated picture of the current picture and the current picture. Whether the current block is inter coded based on an inter prediction mode is determined. When the current block is inter coded, a motion compensated block of the current block is determined based on the inter prediction mode. The parameters of the model are applied to the motion compensated block of the current block to obtain a prediction block of the current block. The current block is encoded in a bitstream based on the prediction block. The encoded bitstream is further transmitted.

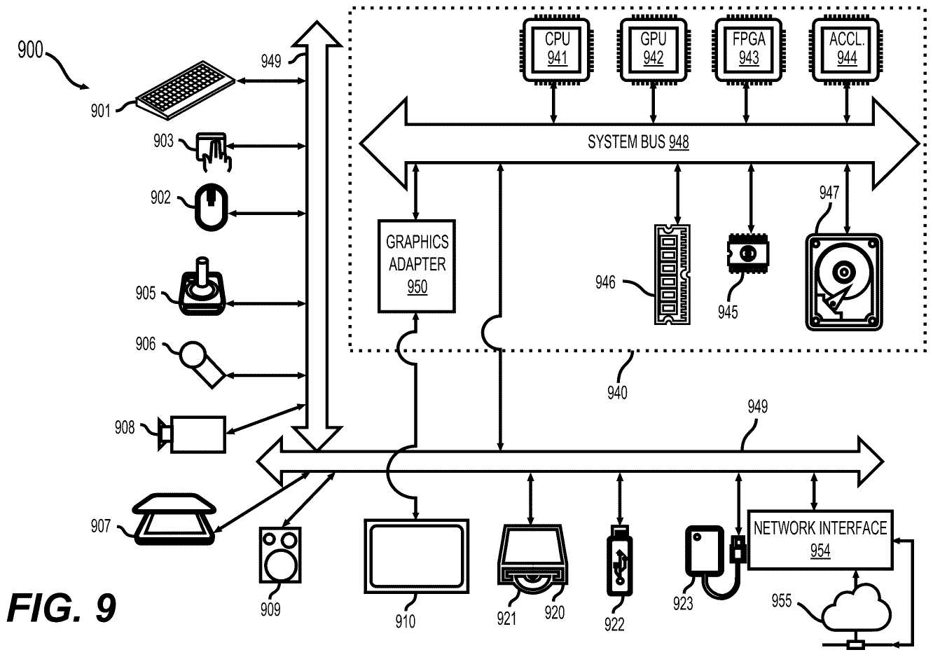

The techniques described above, can be implemented as computer software using computer-readable instructions and physically stored in one or more computer-readable media. For example, FIG. 9 shows a computer system (900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 9 for computer system (900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (900).

Computer system (900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (901), mouse (902), trackpad (903), touch screen (910), data-glove (not shown), joystick (905), microphone (906), scanner (907), camera (908).

Computer system (900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (910), data-glove (not shown), or joystick (905), but there can also be tactile feedback devices that do not serve as input devices), audio output devices (such as: speakers (909), headphones (not depicted)), visual output devices (such as screens (910) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (900) can also include human accessible storage devices and their associated media such as optical media including CD/DVD ROM/RW (920) with CD/DVD or the like media (921), thumb-drive (922), removable hard drive or solid state drive (923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (900) can also include an interface (954) to one or more communication networks (955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (949) (such as, for example USB ports of the computer system (900)); others are commonly integrated into the core of the computer system (900) by attachment to a system bus as described below (for example Ethernet interface into a PC computer system or cellular network interface into a smartphone computer system). Using any of these networks, computer system (900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (940) of the computer system (900).

The core (940) can include one or more Central Processing Units (CPU) (941), Graphics Processing Units (GPU) (942), specialized programmable processing units in the form of Field Programmable Gate Areas (FPGA) (943), hardware accelerators for certain tasks (944), graphics adapters (950), and so forth. These devices, along with Read-only memory (ROM) (945), Random-access memory (946), internal mass storage such as internal non-user accessible hard drives, SSDs, and the like (947), may be connected through a system bus (948). In some computer systems, the system bus (948) can be accessible in the form of one or more physical plugs to enable extensions by additional CPUs, GPU, and the like. The peripheral devices can be attached either directly to the core's system bus (948), or through a peripheral bus (949). In an example, the screen (910) can be connected to the graphics adapter (950). Architectures for a peripheral bus include PCI, USB, and the like.

CPUs (941), GPUs (942), FPGAs (943), and accelerators (944) can execute certain instructions that, in combination, can make up the aforementioned computer code. That computer code can be stored in ROM (945) or RAM (946). Transitional data can also be stored in RAM (946), whereas permanent data can be stored for example, in the internal mass storage (947). Fast storage and retrieve to any of the memory devices can be enabled through the use of cache memory, that can be closely associated with one or more CPU (941), GPU (942), mass storage (947), ROM (945), RAM (946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (900), and specifically the core (940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (940) that are of non-transitory nature, such as core-internal mass storage (947) or ROM (945). The software implementing various aspects of the present disclosure can be stored in such devices and executed by core (940). A computer-readable medium can include one or more memory devices or chips, according to particular needs. The software can cause the core (940) and specifically the processors therein (including CPU, GPU, FPGA, and the like) to execute particular processes or particular parts of particular processes described herein, including defining data structures stored in RAM (946) and modifying such data structures according to the processes defined by the software. In addition or as an alternative, the computer system can provide functionality as a result of logic hardwired or otherwise embodied in a circuit (for example: accelerator (944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of video decoding, including: receiving a video bitstream including coded information of a current block in a current picture of a video; determining parameters of a model based on the coded information in the video bitstream, the parameters of the model including parameters derived based on a motion compensated picture of the current picture and the current picture; determining whether the current block is inter coded based on an inter prediction mode; when the current block is inter coded, determining a motion compensated block of the current block based on the inter prediction mode; applying the parameters of the model to the motion compensated block of the current block to obtain a prediction block of the current block; and reconstructing the current block based on the prediction block.

(2) The method of feature (1), in which the model includes a plurality of sub-models indicated by a plurality of model classifiers, each of the plurality of model classifiers corresponding to a respective coded picture of the video.

(3) The method of feature (1) or (2), in which: the model is a filtering model with a plurality of classifiers, each of the plurality of classifiers corresponds to a respective set of filter coefficients of an N-tap filter, N being a positive integer, and the plurality of classifiers includes at least one of a direction-based classifier, a variance-based classifier, or a sample-value-based classifier.

(4) The method of any one of features (1) to (3), in which the determining the parameters further includes: obtaining a first flag in the video bitstream, the first flag indicating whether the model is to be applied to the current block, and when the first flag indicates that the model is to be applied to the current block, determining the parameters of the model from the coded information.

(5) The method of feature (4), in which: the coded information includes a second flag indicating whether parameters of previous coding slices or previous coding pictures are applied to the current block, and the determining the parameters further includes: when the second flag indicates that the parameters of the previous coding slices or the previous coding pictures are applied to the current block, determining the parameters of the model from one of the previous coding slices or one of the previous coding pictures that is indicated by a syntax element in the video bitstream.

(6) The method of any one of features (1) to (5), in which the reconstructing the current block further includes: reconstructing the current block based on a combination of the motion compensated block and the prediction block of the current block.

(7) The method of any one of features (1) to (6), in which the applying further includes: when the current block is partitioned into a first portion and a second portion based on a geometric partition, applying the parameters of the model to (i) the first portion of the current block to obtain a first prediction portion of the current block and (ii) the second portion of the current block to obtain a second prediction portion of the current block; and applying a geometric partition mask to the first prediction portion and the second prediction portion to obtain the prediction block of the current block.

(8) The method of any one of features (1) to (7), in which the applying further includes: performing a luma reshaping or a luma mapping to luma samples of the prediction block to convert the luma samples into a mapped domain.

(9) The method of any one of features (1) to (8), in which the applying further includes: applying the parameters of the model to the motion compensated block of the current block when one of (i) a local illumination compensation mode and (ii) a decoder-side optical-flow-based method is not applied to the current block.

(10) The method of any one of features (1) to (9), in which the applying further includes: when the current block is coded in a bi-prediction mode and the motion compensated block includes a first motion compensated block in a first direction of the bi-prediction mode and a second motion compensated block in a second direction of the bi-prediction mode, applying the parameters of the model to the first motion compensated block to obtain a first prediction block and the second motion compensated block to obtain a second prediction block; and determining the prediction block of the current block as a weighted combination of the first prediction block and the second prediction block.

(11) The method of any one of features (1) to (10), in which the applying further includes: determining a correlation between a luma prediction component of the motion compensated block and a chroma prediction component of the motion compensated block; determining a luma reconstructed component of the current block based on the luma prediction component; applying the parameters of the model to the luma reconstructed component of the current block to obtain a processed luma reconstructed component; and determining a predicted chroma prediction component of the current block based on the determined correlation and the processed luma reconstructed component.

(12) The method of feature (11), in which the reconstructing further includes: reconstructing a chroma component of the current block based on a combination of the chroma prediction component of the motion compensated block and the predicted chroma prediction component.

(13) The method of any one of features (1) to (12), in which: whether the parameters of the model are to be applied to the motion compensated block of the current block is determined based on a comparison between a temporal identifier of the current block and a threshold value.

(14) The method of any one of features (1) to (13), in which: the motion compensated picture is constructed with a plurality of N×N motion compensated blocks of the current picture in a raster scanning order, N being a positive integer, and a reference picture to determine the plurality of N×N motion compensated blocks is (i) one of reference pictures in a decoded picture buffer or (ii) one of reference pictures in a reference list of the current picture.

(15) The method of any one of features (1) to (14), in which the motion compensated picture is determined by one of an optical flow, a frame rate up conversion, a temporal motion vector predictor, a subblock-based temporal motion vector predictor, and a neural network-based reference picture construction.

(16) The method of any one of features (1) to (15), in which the applying further includes: applying the parameters of the model to a coded picture when the coded picture is coded without block level information, the block level information including at least one of transformed residual data and header information of one of a coding unit, a coding tree unit (CTU), and a superblock.

(17) The method of feature (16), in which the coded picture is generated based on one of (i) a frame rate up conversion and (ii) an optical flow when a forward reference picture and a backward reference picture of the coded picture are available.

(18) The method of feature (16), in which: the coded picture is generated based a plurality of N×N motion compensated blocks, and each of the plurality of N×N motion compensated blocks is defined based on a collocated temporal motion vector, the collocated temporal motion vector being one of a uni-prediction motion vector and a bi-directional motion vector.

(19) A method of video encoding, including: determining parameters of a model for a current block in a current picture of a video, the parameters of the model including parameters derived based on a motion compensated picture of the current picture and the current picture; determining whether the current block is inter coded based on an inter prediction mode; when the current block is inter coded, determining a motion compensated block of the current block based on the inter prediction mode; applying the parameters of the model to the motion compensated block of the current block to obtain a prediction block of the current block; and encoding the current block in a bitstream based on the prediction block.

(20) A non-transitory computer-readable storage medium storing instructions which when executed by a processor cause the processor to perform an encoding method including: determining parameters of a model for a current block in a current picture of a video, the parameters of the model including parameters derived based on a motion compensated picture of the current picture and the current picture; determining whether the current block is inter coded based on an inter prediction mode; when the current block is inter coded, determining a motion compensated block of the current block based on the inter prediction mode; applying the parameters of the model to the motion compensated block of the current block to obtain a prediction block of the current block; encoding the current block in a bitstream based on the prediction block; and transmitting the encoded bitstream.

(21) An apparatus for video decoding, including processing circuitry that is configured to perform the method of any one of features (1) to (18).

(22) An apparatus for video encoding, including processing circuitry that is configured to perform the method of feature (19).

(23) A non-transitory computer-readable storage medium storing instructions which when executed by at least one processor cause the at least one processor to perform the method of any of features (1) to (19).

What is claimed is:

1. A method of video decoding, comprising:
receiving a video bitstream including coded information of a current block in a current picture of a video;
determining parameters of a model based on the coded information in the video bitstream, the parameters of the model including parameters determined based on a motion compensated picture of the current picture and the current picture;
determining whether the current block is inter coded based on an inter prediction mode; and
when the current block is inter coded, determining a motion compensated block of the current block based on the inter prediction mode;
applying the parameters of the model to the motion compensated block of the current block to obtain a prediction block of the current block, and
reconstructing the current block based on the prediction block.

2. The method of claim 1, wherein the model includes a plurality of sub-models indicated by a plurality of model classifiers, each of the plurality of model classifiers corresponding to a respective coded picture of the video.

3. The method of claim 1, wherein:
the model is a filtering model with a plurality of classifiers,
each of the plurality of classifiers corresponds to a respective set of filter coefficients of an N-tap filter, N being a positive integer, and
the plurality of classifiers includes at least one of a direction-based classifier, a variance-based classifier, or a sample-value-based classifier.

4. The method of claim 1, wherein the determining the parameters further comprises:
obtaining a first flag in the video bitstream, the first flag indicating whether the model is to be applied to the current block, and
when the first flag indicates that the model is to be applied to the current block, determining the parameters of the model from the coded information.

5. The method of claim 4, wherein:
the coded information includes a second flag indicating whether parameters of previous coding slices or previous coding pictures are applied to the current block, and
the determining the parameters further comprises:
when the second flag indicates that the parameters of the previous coding slices or the previous coding pictures are applied to the current block,
determining the parameters of the model from one of the previous coding slices or one of the previous coding pictures that is indicated by a syntax element in the video bitstream.

6. The method of claim 1, wherein the reconstructing the current block further comprises:
reconstructing the current block based on a combination of the motion compensated block and the prediction block of the current block.

7. The method of claim 1, wherein the applying further comprises:
when the current block is partitioned into a first portion and a second portion based on a geometric partition,
applying the parameters of the model to (i) the first portion of the current block to obtain a first prediction portion of the current block and (ii) the second portion of the current block to obtain a second prediction portion of the current block; and
applying a geometric partition mask to the first prediction portion and the second prediction portion to obtain the prediction block of the current block.

8. The method of claim 1, wherein the applying further comprises:
performing a luma reshaping or a luma mapping to luma samples of the prediction block to convert the luma samples into a mapped domain.

9. The method of claim 1, wherein the applying further comprises:
applying the parameters of the model to the motion compensated block of the current block when one of (i) a local illumination compensation mode and (ii) a decoder-side optical-flow-based method is not applied to the current block.

10. The method of claim 1, wherein the applying further comprises:
when the current block is coded in a bi-prediction mode and the motion compensated block includes a first motion compensated block in a first direction of the bi-prediction mode and a second motion compensated block in a second direction of the bi-prediction mode,
applying the parameters of the model to the first motion compensated block to obtain a first prediction block and the second motion compensated block to obtain a second prediction block; and
determining the prediction block of the current block as a weighted combination of the first prediction block and the second prediction block.

11. The method of claim 1, wherein the applying further comprises:
determining a correlation between a luma prediction component of the motion compensated block and a chroma prediction component of the motion compensated block;
determining a luma reconstructed component of the current block based on the luma prediction component;
applying the parameters of the model to the luma reconstructed component of the current block to obtain a processed luma reconstructed component; and
determining a predicted chroma prediction component of the current block based on the determined correlation and the processed luma reconstructed component.

12. The method of claim 11, wherein the reconstructing further comprises:
reconstructing a chroma component of the current block based on a combination of the chroma prediction component of the motion compensated block and the predicted chroma prediction component.

13. The method of claim 1, wherein:
whether the parameters of the model are to be applied to the motion compensated block of the current block is determined based on a comparison between a temporal identifier of the current block and a threshold value.

14. The method of claim 1, wherein:
the motion compensated picture is constructed with a plurality of N×N motion compensated blocks of the current picture in a raster scanning order, N being a positive integer, and
a reference picture to determine the plurality of N×N motion compensated blocks is (i) one of reference pictures in a decoded picture buffer or (ii) one of reference pictures in a reference list of the current picture.

15. The method of claim 1, wherein the motion compensated picture is determined by one of an optical flow, a frame rate up conversion, a temporal motion vector predictor, a subblock-based temporal motion vector predictor, and a neural network-based reference picture construction.

16. The method of claim 1, wherein the applying further comprises:
applying the parameters of the model to a coded picture when the coded picture is coded without block level information, the block level information including at least one of transformed residual data and header information of one of a coding unit, a coding tree unit (CTU), and a superblock.

17. The method of claim 16, wherein the coded picture is generated based on one of (i) a frame rate up conversion and (ii) an optical flow when a forward reference picture and a backward reference picture of the coded picture are available.

18. The method of claim 16, wherein:
the coded picture is generated based a plurality of N×N motion compensated blocks, and
each of the plurality of N×N motion compensated blocks is defined based on a collocated temporal motion vector, the collocated temporal motion vector being one of a uni-prediction motion vector and a bi-directional motion vector.

19. A method of video encoding, comprising:
determining parameters of a model for a current block in a current picture of a video, the parameters of the model including parameters determined based on a motion compensated picture of the current picture and the current picture;
determining whether the current block is inter coded based on an inter prediction mode; and
when the current block is inter coded, determining a motion compensated block of the current block based on the inter prediction mode;
applying the parameters of the model to the motion compensated block of the current block to obtain a prediction block of the current block, and
encoding the current block in a bitstream based on the prediction block.

20. A non-transitory computer-readable storage medium storing instructions which when executed by a processor cause the processor to perform an encoding method comprising:
determining parameters of a model for a current block in a current picture of a video, the parameters of the model including parameters determined based on a motion compensated picture of the current picture and the current picture;
determining whether the current block is inter coded based on an inter prediction mode;
when the current block is inter coded, determining a motion compensated block of the current block based on the inter prediction mode;
applying the parameters of the model to the motion compensated block of the current block to obtain a prediction block of the current block,
encoding the current block in a bitstream based on the prediction block; and
transmitting the encoded bitstream.
